(19) United States
(12) Patent Application Publication
(10) Pub. No.: US 2017/0370114 A1
(43) Pub. Date: Dec. 28, 2017

(54) FALL HAZARD SAFETY SYSTEM

(71) Applicant: G&R Machine Tool, Inc., Taylor, MI (US)

(72) Inventors: Jorge KORNIJENKO, Taylor, MI (US); Alejandro KORNIJENKO, Romulus, MI (US)

(21) Appl. No.: 15/631,060

(22) Filed: Jun. 23, 2017

Related U.S. Application Data
(60) Provisional application No. 62/354,156, filed on Jun. 24, 2016.

(51) Int. Cl. E04G 21/32; A62B 35/00

(52) U.S. Cl. CPC E04G 21/3276; E04G 21/3204; A62B 35/0006; A62B 35/0068; E04G 21/3261

(57) ABSTRACT

A fall hazard safety system includes first and second base units movable with respect to each other. First and second support members are secured to and extend from the first and second base units, respectively. A crossbeam is securable to the first and second support members. A tether is secured to the crossbeam and is securable to a harness for harnessing an individual when support on an elevated surface and for reducing a fall hazard of the individual falling from the elevated surface.

### CROSS-REFERENCE TO RELATED APPLICATIONS

This application claims the benefit of U.S. provisional application Ser. No. 62/354,156 filed Jun. 24, 2016, the disclosure of which is hereby incorporated in its entirety by reference herein.

### TECHNICAL FIELD

This disclosure relates to a mobile yet selectively stationary fall hazard safety system for preventing an individual from falling while working from an elevated location.

### SUMMARY

According to one embodiment, a fall hazard safety system includes first and second base units movable with respect to each other. First and second support members are secured to and extend from the first and second base units, respectively. A crossbeam is securable to the first and second support members. A tether is secured to the crossbeam and is securable to a harness for harnessing an individual when support on an elevated surface and for reducing a fall hazard of the individual falling from the elevated surface.

The first and second support members may be rotatable relative to the first and second base units such that the first and second support members are configured to rotate between a stowed position and an upright position.

The first and second support members each may include a lower extending member and an upper extending member translatable from a lower position to a higher position relative to the lower extending member.

The first and second base units each may include a recess for receiving a portion of the lower extending portion when its respective support member is in the upright position.

Each upper extending member may be lockable in the lower and higher positions relative to the lower extending member.

The first and second base units each may include a rack and pinion to translate the upper extending member from the lower position to the higher position relative to the lower extending member.

The base units each may include a wheel for actuating the rack and pinion to translate the upper extending member from the lower position to the higher position relative to the lower extending member.

The first and second base units each may include a pivot axis, and the first and second support members are configured to rotate between a stowed position and an upright position about the first and second pivot axes.

The upper extending members each may include a distal end, and the crossbeam may be securable to the distal ends when the first and second support members are in the upright position.

The distal ends each may include a clamp, and the crossbeam is securable to the distal ends via the clamps.

The upper extending members may be at least partially translatable within the lower extending members.

The crossbeam may be an I-beam.

According to another embodiment, a fall hazard safety devices comprises a base unit and a support member secured to an extending form the base unit. The support member is rotatable about the base unit between a stowed position and an upright position. The support member includes a lower extending portion pivotably connected to the base unit and an upper extending portion translatably connected to the lower extending portion for movement between a lower and upper position relative the lower extending portion. The support member includes a distal end configured to secure a portion of a crossbeam having a harness for harnessing an individual when supported on an elevated surface and for reducing a fall hazard of the individual falling from the elevated surface.

The base unit may include a cross member extending through a portion of the lower extending portion, securing the lower extending portion to the base unit.

The base unit may include a weighted lower portion configured to remain stationary when the individual is supported on an elevated surface and for reducing a fall hazard of the individual falling from the elevated surface.

According to another embodiment, a method of reducing fall hazard of an individual supported on an elevated surface is provided. The method includes moving first and second fall hazard safety devices of embodiments described above into first and second positions straddling the elevated surface. The method also includes securing a crossbeam to the first and second fall hazard safety devices. The method also includes securing a harness to the individual, the harness being secured to a tether that is secured to the crossbeam.

The method may further include adjusting the height of each of the first and second fall hazard safety devices.

The crossbeam securing stem may include clamping the crossbeam to the first and second support members.

The method may further include tethering the individual to the crossbeam when the first and second support members are in the upright position.

The method may further include untethering the individual from the crossbeam and removing the crossbeam from the first and second members before rotating the first and second fall hazard safety devices from the upright position to the stowed position.

### BRIEF DESCRIPTION OF THE DRAWINGS

FIG. 1 is a side view of a fall hazard safety device in a stowed or transporting position, according to an embodiment.

FIG. 2A is a side view of a fall hazard safety device in an upright position, according to an embodiment.

FIG. 2B is a front view of the fall hazard safety device of FIG. 2A in the upright position.

FIG. 2C is an elevated perspective view of the fall hazard safety device of FIG. 2A in the upright position.

FIG. 3A is a front view of a fall hazard safety system according to an embodiment in which two fall hazard safety devices are in the upright position and are connected by a crossbeam to enable an individual to tether while working from an elevated surface.

FIG. 3B is an elevated perspective view of the fall hazard safety system of FIG. 3A.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

According to various embodiments of this disclosure, a fall hazard safety system is provided for securing an individual to a structure when that individual is working on an elevated surface. The fall hazard safety system includes a pair of transportable bases that can be set up on either side of the elevated surface. This allows the system to be modular in size in all three dimensions. Each base has a support member pivotally or rotatably secured to the base. When pivoted upward to a vertical, upright position, the support members are able to support a crossbeam connected to each of the upright support members. The individual can then tether himself to the crossbeam at an elevated height above a working area such as an elevated surface.

Various aspects and additional embodiments and detail of this system are described below.

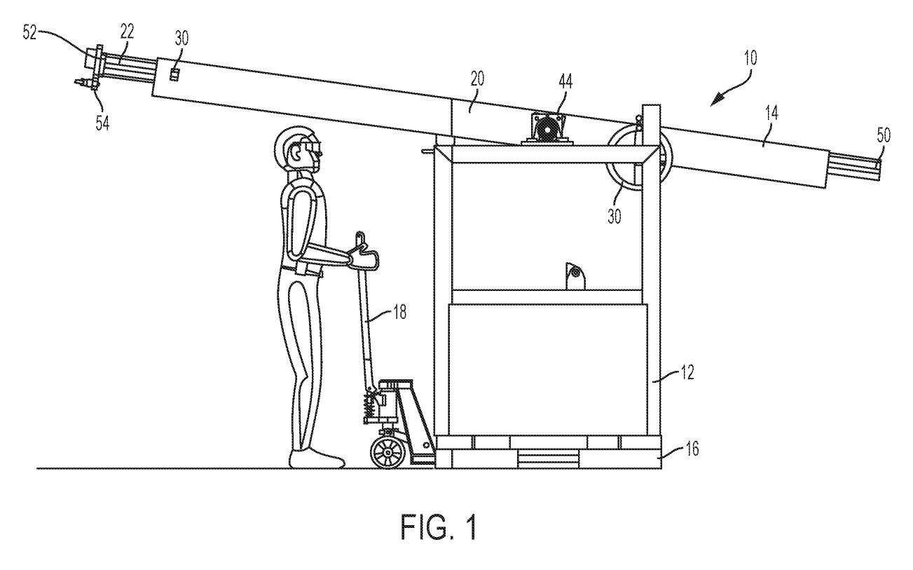

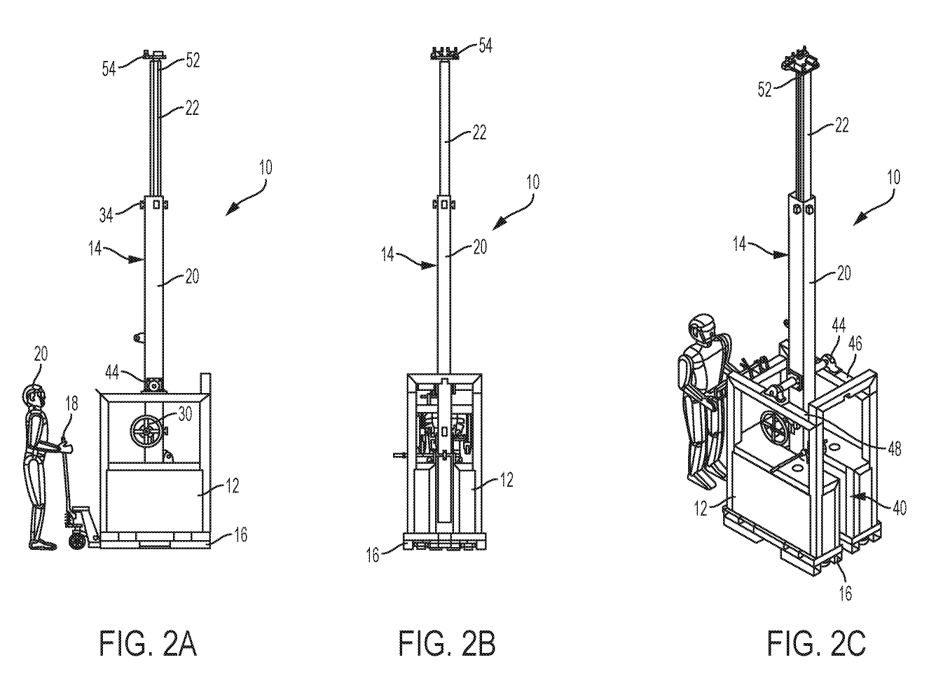

FIG. 1 shows one of two fall hazard safety units 10. The unit 10 has a base 12 and a support member 14. The support member 14 is rotatable or pivotally secured to the base 12. This enables the unit 10 to move between a stowed or transport position (shown in FIG. 1) and an upright, working position (shown in FIG. 2A-2C). When in the transport position, the unit 10 is able to be easily transported to a desired location. To accommodate transportation, the base 12 includes grooves, tracks, apertures, or other such engagement features 16 like a pallet at the bottom of the base 12 that are sized and configured to receive or engage with a transporting mechanism such as a fork lift dolly or pallet transporter 18. An individual 20 can slide the pallet transporter into the engagement features 16, and lift the base off of the ground to transport the unit to the desired location.

The rotatable nature of the support member 14 allows for the support member to rotatably transition between the stowed position (or storage position) and the upright position (or working position). The support member 14 can include a lower extending member 20 and an upper extending member 22. The lower extending member may be directly pivotally or directly rotatably coupled to the base. A portion of or the entire upper extending member can be linearly translatable with respect to the lower extending member. The upper extending member may be configured to telescopically extend from the lower extending member in that the upper extending member can move linearly within the lower extending member. This allows the upper extending member to extend the length of the support member such that in the working position the height of the unit 10 can reach a selectable height. In some embodiments, the lower extending member provides as a sleeve about the upper extending member. In this fashion, the lower extending member 20 can be referred to as an outer member, and the upper extending member 22 can be referred to as an inner extending member as it is located inward of the outer member.

To extend the upper extending member 22 with respect to the lower extending member 20, a rack and pinion device may be provided within the support member 14. For example, the individual can turn a lever or crank 30, causing a pinion with in the support member 14 to turn. Teeth are provided on the pinion, and corresponding teeth and grooves are provided on the rack fixed to the upper extending member. Turning of the lever or crank 30 rotates the pinion which causes linear translation of the rack, therefore translating the upper extending member 22. A locking device or biasing device may be provided to fix the rack and pinion device at each tooth/groove such that the upper extending member is fixed in position if the individual ceases to turn the lever. This provides a safety measure, assuring the upper extending member does not undesirably retract during use.

The lower extending member may be provided with an aperture 32 that aligns with one of several apertures in the upper extending member. A pin 34 can be placed through the apertures of the lower extending member and upper extending member to further lock the support member at a desired height. A pin can also be placed in a hole in the lower extending member to secure the support member in the upright position.

The base 12 includes a groove 40, track, or the like that is sized and configured to receive the support member when the support member is in the upright position. This allows the support member 14 to be at least partially received by or disposed in the base 12 when in the upright position.

The lower extending member can be rotatably fixed to the base by a rod 44. The rod provides a pivot point for the support member. The rod is secured to two rails 46, 48 of the base so that the support member 14 can pivot between the rails 46, 48 between the stowed position and the upright position.

The upper extending member 22 has a proximal or lower end 50, and a distal or upper end 52. A plate 54 is secured to the distal end 52 of the upper extending member 22. In one embodiment, the plate 54 is clamped to the distal end to facilitate removal of the plate after the support member is used in the upright position as a fall hazard safety system. In another embodiment, the plate 54 is fixed (e.g., bolted) to the distal end.

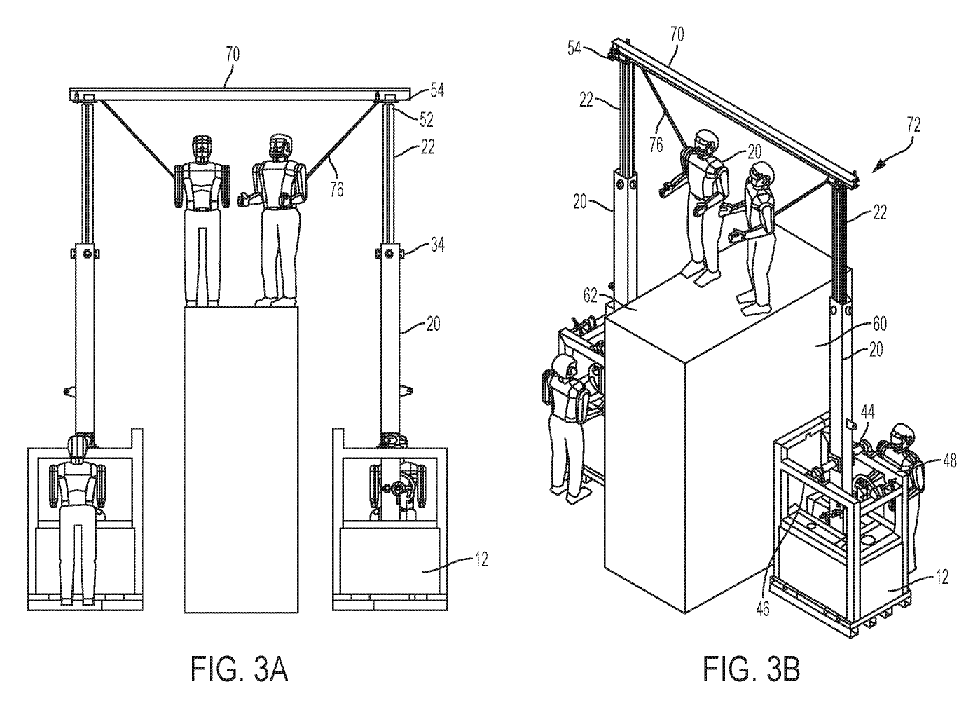

As shown in FIGS. 3A and 3B, two units 10 can be placed to surround a work area 60 with one unit 10 on either side of the work area such as an elevated surface 62. The plates on either upper extending member are configured to support a crossbeam 70 connected both units. In one embodiment, the crossbeam is clamped to the plates 54 to facilitate attachment and removal of the crossbeam 70 when in use. The combination of the two safety units 10 connected together, along with other structure described herein, form a fall hazard safety system 72.

One or more harness or tether 76 may be selectively securable to either the crossbeam 70 or the distal end 52. The tethers 76 can be rope, bungee, cord, or the like with sufficient strength to hold an individual attached thereto. The individual 20 may wear a harness that can secure to the tether to secure the individual to the system. This allows the individual to work on the elevated surface 62 while confident that if the individual were to slip and fall, he would be held at the elevated surface 62 rather than falling off the side of the elevated surface.

The mobility of the units 10 allows the system to be placed at different sized and located work stations. The units 10 can be moved in the transport position to a desired location. Once at the desired work station, the units 10 can be rotated into the upright position. Then, the upper extending member 22 can be extended by, for example, the rack and pinion device. Once extended, the crossbeam 70 can be attached to two of the upper extending members 22 at the plates 54. The individual can then tether himself to the crossbeam 70 while working from the elevated surface 62. When work is complete, the individual can untether himself, the crossbeam 70 can be removed, the upper extending members 22 can be retracted, and the units 10 can be rotated into their transport positions whereupon the units can be transported to another work station.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fall hazard safety system comprising:
first and second base units movable with respect to each other;
first and second support members secured to and extending from the first and second base units, respectively;
a crossbeam securable to the first and second support members; and
a tether secured to the crossbeam and securable to a harness for harnessing an individual when supported on an elevated surface and for reducing a fall hazard of the individual falling from the elevated surface.

2. The fall hazard safety system of claim 1, wherein the first and second support members are rotatable relative to the first and second base units such that the first and second support members are configured to rotate between a stowed position and an upright position.

3. The fall hazard safety system of claim 2, wherein the first and second support members each include a lower extending member and an upper extending member translatable from a lower position to a higher position relative to the lower extending member.

4. The fall hazard safety system of claim 3, wherein the first and second base units each include a recess for receiving a portion of the lower extending portion when its respective support member is in the upright position.

5. The fall hazard safety system of claim 3, wherein each upper extending member is lockable in the lower and higher positions relative to the lower extending member.

6. The fall hazard safety system of claim 3, wherein the first and second base units each include a rack and pinion to translate the upper extending member from the lower position to the higher position relative to the lower extending member.

7. The fall hazard safety system of claim 6, wherein the base units each include a wheel for actuating the rack and pinion to translate the upper extending member from the lower position to the higher position relative to the lower extending member.

8. The fall hazard safety system of claim 3, wherein the first and second base units each include a pivot axis, and the first and second support members are configured to rotate between a stowed position and an upright position about the first and second pivot axes.

9. The fall hazard safety system of claim 3, wherein the upper extending members each include a distal end, and the crossbeam is securable to the distal ends when the first and second support members are in the upright position.

10. The fall hazard safety system of claim 9, wherein the distal ends each include a clamp, and the crossbeam is securable to the distal ends via the clamps.

11. The fall hazard safety system of claim 3, wherein the upper extending members are at least partially translatable within the lower extending members.

12. The fall hazard safety system of claim 1, wherein the crossbeam is an I-beam.

13. A fall hazard safety device comprising:
a base unit; and
a support member secured to and extending from the base unit;
the support member rotatable about the base unit between a stowed position and an upright position, the support member including a lower extending portion pivotably connected to the base unit and an upper extending portion translatably connected to the lower extending portion for movement between a lower and upper position relative the lower extending portion, and the support member including a distal end configured to secure a portion of a crossbeam having a harness for harnessing an individual when supported on an elevated surface and for reducing a fall hazard of the individual falling from the elevated surface.

14. The fall hazard safety device of claim 13, wherein the base unit includes a cross member extending through a portion of the lower extending portion and securing it to the base unit.

15. The fall hazard safety device of claim 13, wherein the base unit includes a weighted lower portion configured to remain stationary when the individual is supported on an elevated surface and for reducing a fall hazard of the individual falling from the elevated surface.

16. A method of reducing fall hazard of an individual supported on an elevated surface, the method comprising:
moving first and second fall hazard safety devices of claim 13 into first and second positions straddling the elevated surface;
securing a crossbeam to the first and second fall hazard safety devices; and
securing a harness to the individual, the harness being secured to a tether that is secured to the crossbeam.

17. The method of claim 16, further comprising adjusting the height of each of the first and second fall hazard safety devices.

18. The method of claim 16, wherein the crossbeam securing step includes clamping the crossbeam to the first and second support members.

19. The method of claim 16, further comprising tethering the individual to the crossbeam when the first and second support members are in the upright position.

20. The method of claim 16, further comprising untethering the individual from the crossbeams and removing the crossbeam from the first and second members before rotating the first and second fall hazard safety devices from the upright position to the stowed position.
